(19) United States
(12) Patent Application Publication
(10) Pub. No.: US 2006/0027499 A1
(43) Pub. Date: Feb. 9, 2006

(54) Carbon nanotube filter

(75) Inventors: Pulickel M. Ajayan, Clifton Park, NY (US); Saikat Talapatra, Troy, NY (US); Robert Vajtai, Troy, NY (US); Anchal Srivastava, Varanasi (IN); Onkar Nath Srivastava, Varanasi (IN)

Correspondence Address: FOLEY AND LARDNER LLP;SUITE 500, 3000 K STREET NW, WASHINGTON, DC, 20007, US

(73) Assignees: BANARAS HINDU UNIVERSITY; RENSSELAER POLYTECHNIC INSTITUTE

(21) Appl. No.: 11/193,340

(22) Filed: Aug. 1, 2005

Related U.S. Application Data
(60) Provisional application No. 60/599,007, filed on Aug. 5, 2004.

(51) Int. Cl. D01F 9/12; B01D 65/02

(52) U.S. Cl. 210/636; 423/447.2; 210/650; 210/652; 210/321.87; 210/321.88; 210/497.01

(57) ABSTRACT

Monolithic, macroscopic, nanoporous nanotube filters are fabricated having radially aligned carbon nanotube walls. The freestanding filters have diameters and lengths up to several centimeters. A single-step filtering process was demonstrated in two important settings: the elimination of multiple components of heavy hydrocarbons from petroleum, a crucial step in post-distillation of crude oil, and the elimination of bacterial contaminants such as Escherichia coli or the nanometer-sized poliovirus from drinking water. All the filtration processes were repeated several times with completely reproducible results. These nanotube filters can be cleaned repeatedly after each filtration process to regain their full filtering efficiency.

### STATEMENT REGARDING FEDERALLY-SPONSORED RESEARCH OR DEVELOPMENT

The U.S. Government may have certain rights in this invention pursuant to grant number DMR 0117792 from the National Science Foundation.

### BACKGROUND OF THE INVENTION

The present invention relates generally to filters and more particularly to macroscopic nanotube structures useful for filtering fluids.

The ability to fabricate robust membrane-like structures with carbon nanotubes (CNTs) can lead to a range of applications in separation technologies, particularly given the selective adsorption properties of nanotube surfaces. See Casavant, M. J. et al., Neat macroscopic membranes of aligned carbon nanotubes, J. Appl. Phys. 93, 2153-2156 (2003); Miller, S. A. et al., Electroosmotic flow in template-prepared carbon nanotube membranes, J. Am. Chem. Soc. 123, 12335-12342 (2001); Long, R. Q. & Yang, R. T. Carbon nanotubes as superior sorbent for dioxin removal, J. Am. Chem. Soc. 123, 2058-2059 (2001); Yan-Hui, L. et al., Adsorption of fluorine from water by aligned carbon nanotubes, Mater. Res. Soc. Bull. 38, 469-476 (2003). But in order to perform various separation applications with nanoscale structures in a practical way, appropriate large-scale structures need to be designed and built with nanoscale units.

Over the past decade of nanotube research, a variety of organized nanotube architectures have been fabricated using chemical vapor (CVD) deposition. The idea of using nanotube structures in separation technology has been proposed, but building macroscopic structures that have controlled geometric shapes, density and dimensions for specific applications still remains a challenge. See Dresselhaus, M. S. et al., Carbon Nanotubes: Synthesis, Structure, Properties and Applications (Topics in Applied Physics Series, Springer, Heidelberg, 2001); Li, W. Z. et al., Large scale synthesis of aligned carbon nanotubes, Science 274, 1701-1703 (1996); Ren, Z. F. et al. Synthesis of large arrays of well-aligned carbon nanotubes on glass, Science 282, 1105-1107 (1998); Huang, S. M. et al., Controlled fabrication of large-scale aligned carbon nanofiber/nanotube patterns by photolithography, Adv. Mater. 14, 1140-1143 (2002); Wei, B. Q. et al., Organized assembly of carbon nanotubes, Nature 416, 495-496 (2002).

In conventional cellulose nitrate/acetate membrane filters used in water filtration, strong bacterial adsorption on the membrane surface affects their physical properties preventing their reusability as efficient filters. Furthermore, most of the typical filters used for virus filtration are also not reusable.

Accordingly, there is currently a need in the art for reusable filters that have controlled porosity at the nanoscale, and, at the same time, can be formed into macroscopic structures with controlled geometric shapes, density, and dimensions.

### SUMMARY OF THE INVENTION

One embodiment of the invention provides a monolithic, macroscopic, nanoporous nanotube filter, wherein the filter comprises at least one of a hollow or a self-supporting filter.

Another embodiment of the invention provides a method of filtering a fluid comprising passing the fluid through a monolithic, macroscopic, nanoporous nanotube filter.

Another embodiment of the invention provides a method of making a carbon nanotube filter, comprising: (a) providing a carbon nanotube source gas and a catalyst gas onto a heated surface; (b) forming a carbon nanotube filter comprising an array of aligned nanotubes containing nanopores between the nanotubes on the surface; and (c) removing the carbon nanotube filter from the surface.

### BRIEF DESCRIPTION OF THE DRAWINGS

FIG. 1A is a schematic of an apparatus for making a carbon nanotube filter according to an embodiment of the present invention.

FIGS. 1B and 4A are photographs of carbon nanotube filters according to embodiments of the present invention.

FIG. 1C (scale 1 mm), FIG. 2A (scale 100 μm), FIG. 2B (scale 10 μm), and FIG. 2C (scale 5 μm) are SEM images of carbon nanotube filters according to embodiments of the present invention.

FIG. 2D (scale 20 nm), FIG. 2E (scale 5 nm), and FIG. 8 are TEM images of carbon nanotube filters according to embodiments of the present invention.

FIG. 2F is an adsorption-desoprtion curve (i.e., a plot of adsorption versus pressure) and FIG. 2G is a plot of pore width distribution according to an embodiment of the present invention.

FIGS. 3A-C are plots of measured stress versus strain, load versus displacement, and pressure versus time, respectively, of carbon nanotube filters according to an embodiment of the present invention.

FIGS. 4B and 7C are three dimensional schematics of carbon nanotube filters according to embodiments of the present invention.

FIGS. 4C-D, 5A-B, and 6A-B are measured gas chromatographic spectra of fluids before and after passing through carbon nanotube filters according to embodiments of the present invention.

FIGS. 7A-B and 7D-E are photographs of fluids before and after passing through the carbon nanotube filter according to one embodiment of the present invention.

### DETAILED DESCRIPTION OF THE PREFERRED EMBODIMENTS

The specific examples of nanotube filters of the present invention are illustrated in the Figures. However, the present invention should not be considered limited by the structures and methods of the specific examples, which are provided for illustration of the present invention.

The present inventors have developed a method of making monolithic, macroscopic, nanoporous nanotube structures that are useful for the filtration of fluids, such as liquids. In one embodiment, the invention provides a method of making a carbon nanotube filter, comprising: (a) providing a carbon nanotube source gas and a catalyst gas onto a heated surface; (b) forming a carbon nanotube filter comprising an array of aligned nanotubes containing nanopores between the nanotubes on the surface; and (c) removing the carbon nanotube filter from the surface.

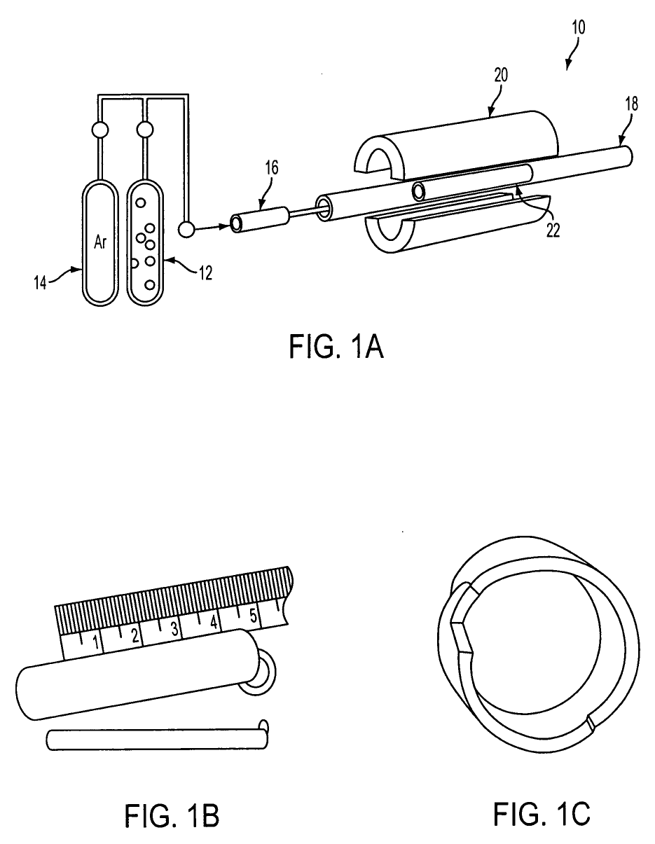

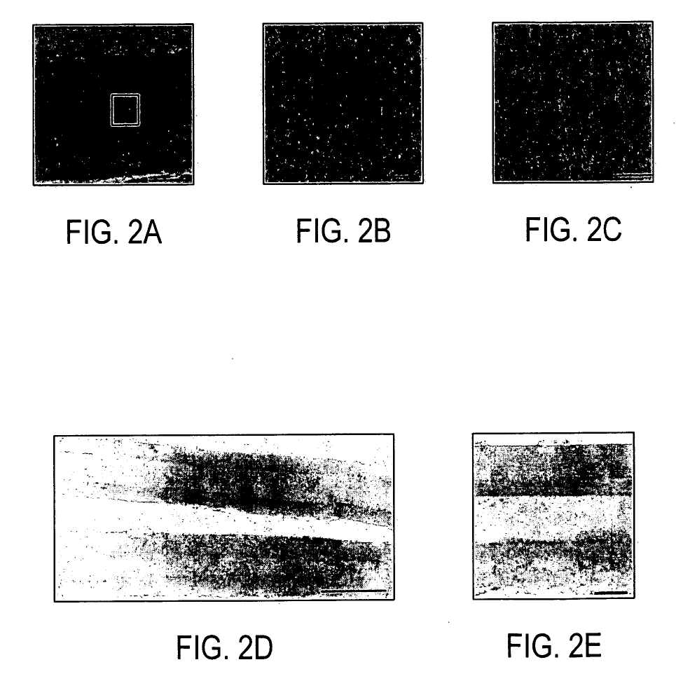

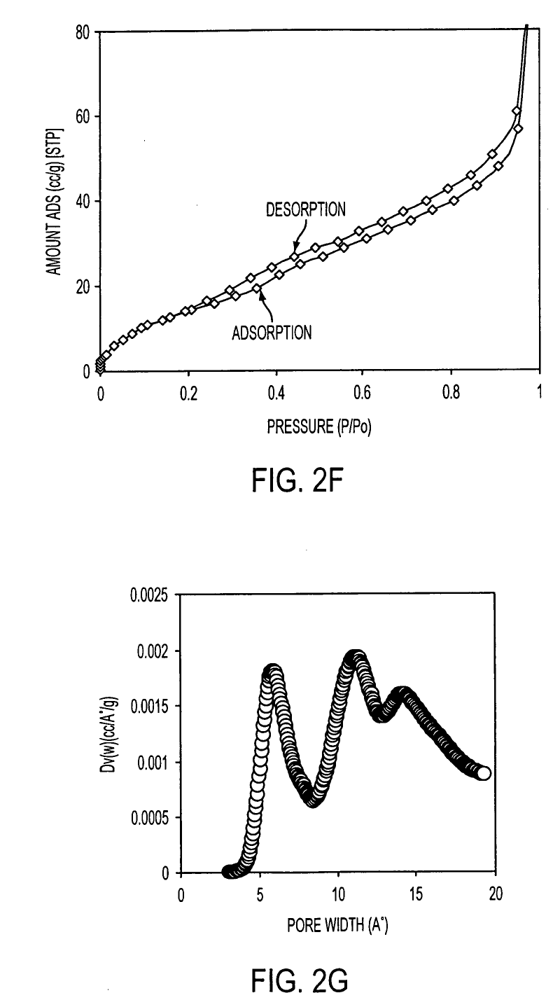

Preferably, the method of making comprises using a continuous spray pyrolysis method by providing the source gas and the catalyst gas to the surface through a nozzle. FIG. 1A depicts a continuous spray pyrolysis apparatus 10 which contains a vessel 12 containing a catalyst gas and a source gas starting material. The source gas comprises benzene and the catalyst gas comprises ferrocene. The starting materials are vaporized and the source and catalyst gases are combined with a carrier gas 14, such as argon, which are then provided through a spray nozzle 16. However, other suitable source, catalyst and carrier gases may be used instead. The gas mixture is released onto the surface of the inner walls of a quartz tube 18 which acts as a removable template, mounted inside a temperature-controlled cylindrical furnace 20. While a cylindrical quartz tube 18 is used in one example, other suitable growth surfaces may also be used. For example, hollow tubes having a rectangular, triangular, oval or other polygonal or irregular internal cross-section may be used instead to form hollow nanotube filters with a corresponding cross-section. Also, materials other than quartz which facilitate nanotube growth may also be used. The size of the nozzle 16 may range from several microns to several millimeters, such as to provide a sufficient flow into the quartz tube 18. The temperature of the furnace 20 is raised to about 700° C. to about 950° C., preferably 900° C. An array of aligned multi-walled carbon nanotubes grows in radial directions on the surface of the walls of the removable quartz tube 18, leading to the formation of a freestanding and continuous hollow cylindrical carbon nanotube filter 22 up to centimeters in diameter and several centimeters long, with walls (ranging from 300 μm to 500 μm thick) consisting of micrometer-length aligned multiwalled nanotubes (MWNTs). The removal of the nanotube filter 22 is done by careful infiltration of acid along the inner wall of the quartz tube 18. Before use in filtration applications, the nanotube filter 22 is subjected to acid treatment for removal of metal impurities followed by ultrasonic cleaning on immersion in acid mixtures. If desired, the growth surface may be coated with a nanotube growth catalyst material. In this case, the catalyst gas may be omitted from the gas mixture.

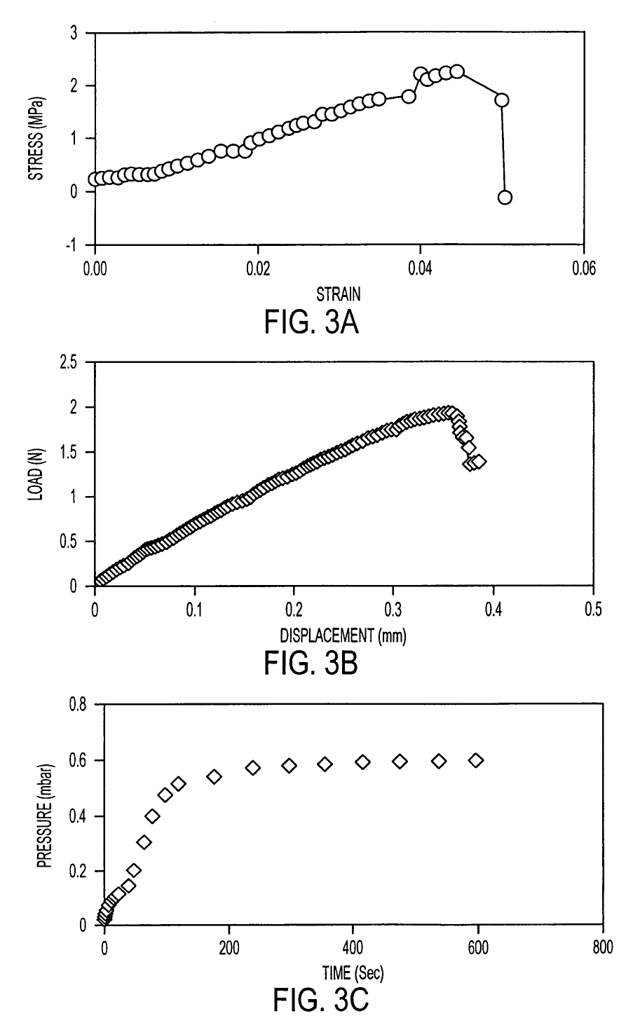

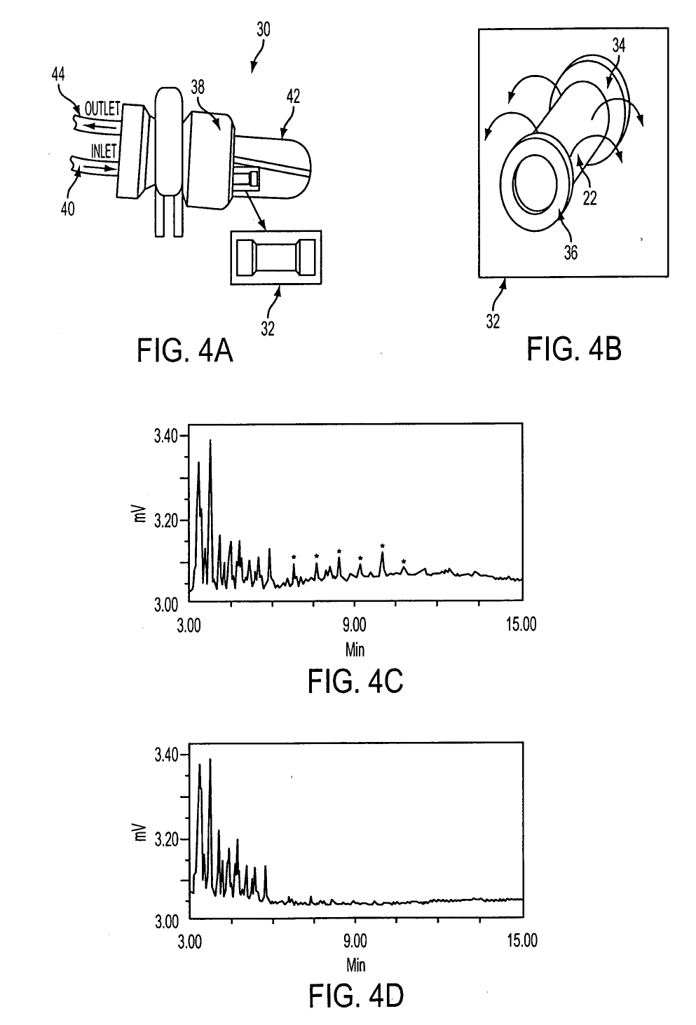

FIG. 1B provides a photograph of the bulk nanotube filter made by the method of the present embodiment of the invention. FIG. 1C provides a scanning electron microscope (SEM) image of the aligned MWNTs with radial symmetry resulting in a hollow cylindrical structure (scale 1 mm). FIG. 2A is a SEM image of the cylindrical macrostructure assembly showing the wall of the bulk tube consisting of aligned MWNTs with lengths equal to the wall thickness (scale 100 μm). A broken piece from a 300-μm-thick macrotube wall, consisting of well-aligned MWNT bundles is shown. The length of the MWNTs corresponds to the wall thickness of the bulk structure. A magnified view of the portion outlined by the rectangle is shown in FIG. 2B, which shows the dense packing of the aligned nanotubes in the membrane (scale 10 μm). FIG. 2C is a SEM image of a thin section extracted from the membrane, and subjected to a short oxidative etching (scale 5 μm). Some thinning of the nanotubes allows better visualization of the nanotube structure that make up the macrotube. FIG. 2D is a transmission electron microscope (TEM) image of the tubes forming the macro structure (scale 20 nm). FIG. 2E is a high-resolution TEM image of a typical nanotube that forms the macrotube structure, showing well-graphitized walls of the MWNT (scale 5 nm). The range of inner and outer diameters of these nanotubes were found to be about 10-12 nm and about 20-40 nm respectively from TEM analysis.

The specific surface area and the nanoporous nature of the nanotube filters were examined using nitrogen adsorption and desorption isotherm measurements preformed at liquid nitrogen temperature (77 K). FIG. 2F shows the adsorption desorption curve. The nanoporous nature of the material was characterized using Howarth-Kawazoe model. The pore size distribution is shown in FIG. 2G. The range of distances between adjacent MWNTs was found to be about 5 and about 20 Angstroms (i.e., about 0.5 nm to about 2 mm), as shown in FIG. 2G. Thus, the majority of nanopores between adjacent nanotubes have a width of about 0.5 to about 2 nm (i.e., the pore widths have a distribution with several peaks between about 0.5 and about 2 nm). Therefore, the filter is capable of blocking substances having a size (such as a diameter) of 0.5-2 nm or greater. Volumetric adsorption isotherm measurement (using high-purity nitrogen gas as adsorbate) at 77.3 K was performed to estimate the specific surface area (SSA) offered by these structures. The SSA value obtained from the monolayer completion of the adsorbed nitrogen was found to be about 50 m² g⁻¹, which is comparable to the SSA of typical MWNTs grown using a chemical vapor deposition process.

In another embodiment, the method of making the filter comprises moving the nozzle 5 and the surface of the removable template relative to each other to deposit the filter material in selected locations on the surface. The gas flow from the nozzle may be selectively turned on and off to form discontinuous nanotube patterns on the surface. The nozzle may provide the gases for different periods of time over different surface locations to allow the method of selective deposition to make a filter with arbitrary patterns of varying thicknesses or to intentionally create macroscopic holes in the filter. The surface need not be a hollow interior surface, and may comprise a flat surface.

In another embodiment, the method of making the filter comprises providing a mask which masks at least a first portion of the surface. The mask may comprise a photoresist mask or another selectively removable material, having one or more patterns on the surface. The filter is then formed on at least one second portion of the surface that is not covered by the mask. The nanotubes may be formed on the mask as well, depending on the mask material. The mask is then removed, along with any nanotubes that formed on the mask. This method may be used to make a filter with arbitrary patterns of varying thicknesses or to intentionally create macroscopic holes in the filter. The surface also need not be a hollow surface and may comprise a flat surface.

In one embodiment, the invention provides a monolithic, macroscopic, nanoporous nanotube filter, wherein the filter comprises at least one of a hollow or a self-supporting filter. While carbon nanotubes have received the most research interest of the all nanotube materials, it is envisaged that other nanotubes, such as boron nitride nanotubes, may be used in the present invention. Indeed, boron nitride nanotubes have comparable, if not superior, properties (e.g., electrical, mechanical, thermal, chemical) to those of carbon nanotubes and are, therefore, attractive candidates for filtration and separation technologies. See M. Ishigami et al., Properties of Boron Nitride Nanotubes, AIP Conference Proceedings 696, 94-99 (2003).

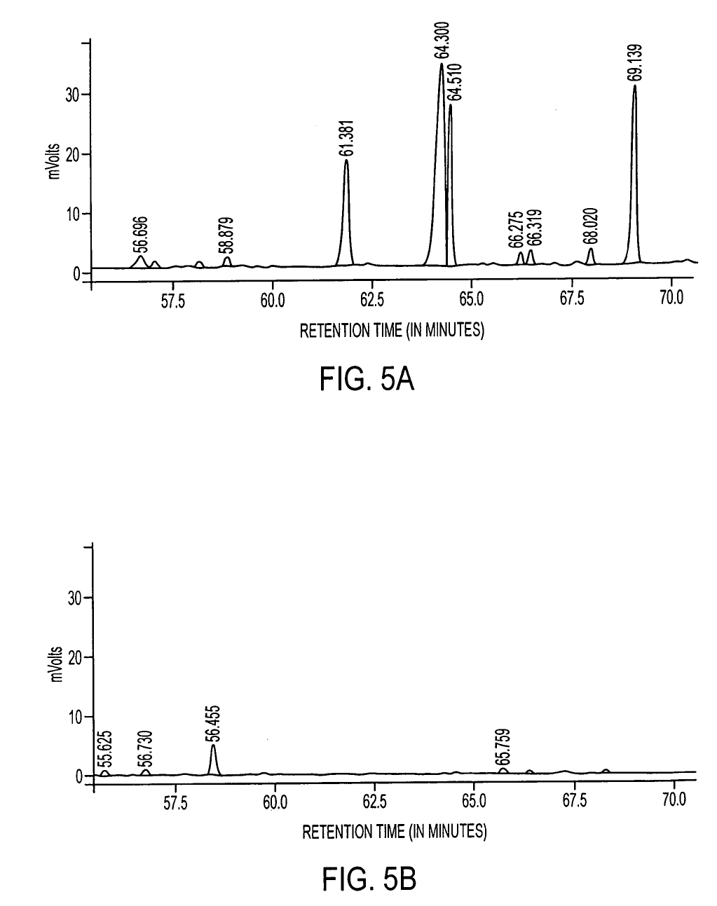

In another embodiment, the filter consists essentially of a self-supporting array of carbon nanotubes. In other words, the nanotube array is preferably free-standing (i.e., not necessarily supported by the original growth surface, and includes only nanotubes and unavoidable impurities introduced during information). In another embodiment, the filter comprises a hollow filter. Preferably, the filter comprises a self-supporting cylindrical array of radially aligned multi-walled carbon nanotubes having at least one open end, as shown in FIGS. 1B and 1C. However, the hollow filter may have other shapes, such as polygonal (rectangular, triangular, etc.) or oval cross-sectional shapes. The filter may have any suitable length and diameter, such that a length and diameter of the filter are preferably more than one centimeter, such as a length of 2-20 cm, for example 2-6 cm, and a diameter (i.e. width) of 0.5-3 cm, for example 1-2 cm. The nanopores are preferably located between adjacent nanotubes of the array. FIG. 2D shows two adjacent multi-walled carbon nanotubes with a nanopore located between the adjacent nanotubes. The filter of the present embodiment is found to be mechanically very stable. The nanotube filters remained stable even after ultrasonic treatment showing the high mechanical stability of the assembled carbon architectures. Direct tensile tests on various small pieces (˜1-2 mm wide) of the assembled structure were performed by applying a load parallel to the bulk tube axis. The values for the Young's modulus obtained from the true stress versus the true strain curves was ˜50 MPa and the tensile strength was ˜2.2 MPa (comparable to other assembled graphitic materials), as shown in FIG. 3A. Three-point bend tests on these bulk structures were performed to quantify the breaking strength of the macro tubes. The fracture load (at the weakest point) of the tube was found to be ˜2 N, as shown in FIG. 3B. Failure-to-pressure tests for the bulk tube shaped filter were conducted by sealing the tube on one end and then evacuating it to 0.01 mbar. The decrement in vacuum inside the bulk tube was dynamically monitored with time. Initially (within 60 s) the pressure inside the tube increased rapidly to ˜0.5 mbar and then slowly (˜200 s) equilibrium was achieved at 0.6 mbar pressure. The time versus inner tube pressure data in FIG. 3C shows that these bulk structures were capable of sustaining a considerable amount of pressure difference (inner wall ˜10⁻² mbar and outer wall 1 atm) and hence suggests the robustness of these solid carbon filters. The ability of the bulk tube to maintain a constant pressure difference also suggests that these structures are devoid of any cracks or surface defects.

In another embodiment, the filter comprises chemically functionalized nanotubes to allow selective chemical filtration of an analyte fluid through the filter. For instance, it is known that different functional groups can be readily introduced onto carbon nanotubes when the nanotubes are treated with different oxidants. J. Zhang et al., Effect of Chemical Oxidation on the Structure of Single-Walled Carbon Nanotubes, J. Phys. Chem. B, 107, 3712 (2003). The presence of functional groups on the outer surfaces of the nanotubes also decreases the inter-nanotube distance and thereby physically constricts the passage of analytes between the nanotubes. In addition to blocking analytes in a fluid that are too large to pass between the nanotubes, a chemically-functionalized nanotube filter provides additional filtration by chemical means (e.g., binding with reactive groups, enhanced absorption by the nanotubes, or hydrophobic/hydrophilic interactions between the analyte and functionalized nanotube).

In another embodiment, the filter is located inside a microcapillary and the nanotubes of the filter comprise an array of radially aligned nanotubes located on the inner wall of the microcapillary. A microcapillary may comprise a portion of a liquid chromatography or other similar liquid separation and testing device and may comprise a porous microcapillary.

In one embodiment, the invention provides a method of filtering a fluid comprising passing the fluid through a monolithic, macroscopic, nanoporous nanotube filter. For example, the potential use of the nanotube filter was explored in the filtration of heavier hydrocarbon species, CₘHₙ (m>12), from hydrocarboneus oil, such as for example, petroleum CₘHₙ (n=2m+2, m=1 to 12), and in the removal of bacteria and viruses from drinking water. However, it should be understood that any fluid containing more than one component may be filtered through the filter, such that one or more solid components are filtered.

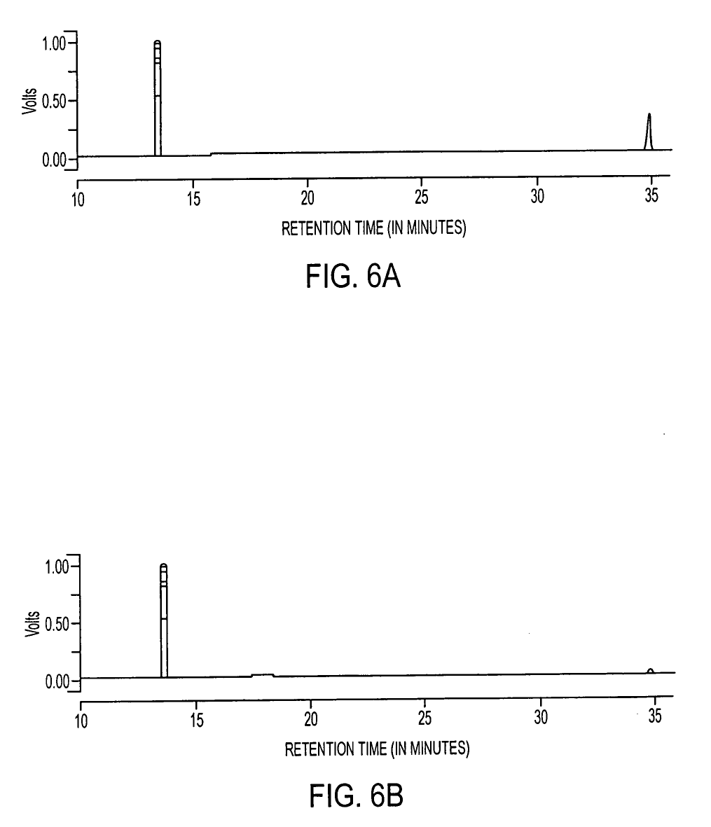

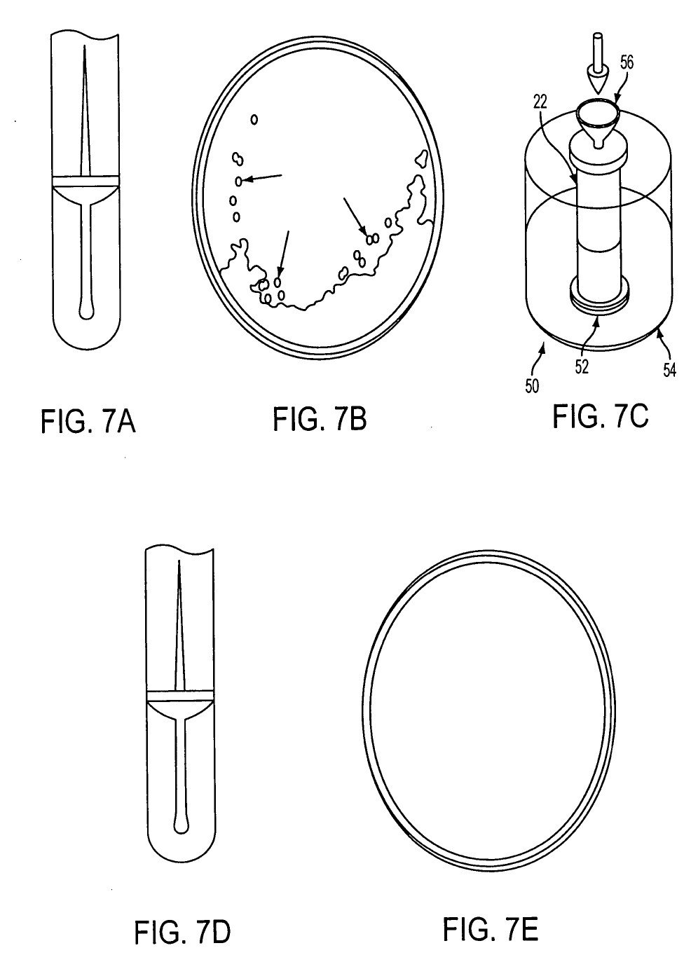

Breaking large hydrocarbons into smaller ones or separating heavier hydrocarbons from crude oil is an important step in gasoline production and improvement of octane quality. Octane number, which depends on the type of hydrocarbon present, also determines the antiknock ability of a fuel. In one embodiment of the invention, the efficient filtration of petroleum (CₘHₙ) was demonstrated by separating multiple components of heavier hydrocarbons from it using the above described bulk nanotube-based filters. FIG. 4A shows one embodiment of the filtration set-up 30 used for heavy hydrocarbon separation. The inset of FIG. 4A shows a freestanding and continuous hollow cylindrical carbon nanotube filter 22 mounted as a filter assembly 32. In FIG. 4B, the filter assembly 32 comprises the hollow cylindrical carbon nanotube filter 22 which is closed at one end with an aluminum cap 34, while the other end is kept open serving as a port 36. In FIG. 4A, the filter assembly 32 is mounted to a metal body 38 via the port 36, into which the fluid is provided by an inlet tube 40. A reservoir 42 collects a portion of the fluid that has passed through the nanopores between the nanotubes of the nanotube filter 22. An outlet tube 44 allows a portion of the fluid to be collected.

Samples of petroleum were analyzed by standard gas chromatography (GC; Nucon-5800C and Varian-1800) and flame-ionization detection techniques before and after passing through the filter of the present embodiment of the invention. The sample to be separated was introduced into a fused silica capillary column, having a length of 10 m and inner diameter of 530 μm, through an injection port and was swept down the column by nitrogen. The loop volume used for injection was 50 μl. The temperature of the column was controlled in such a way that the substances being separated had a suitable vapor pressure and could move through the column at a rate proportional to their respective vapor pressures. The temperature of the column was set at 50° C. for two minutes and thereafter was raised to 240° C. at a rate of 20° C. per minute. The detector temperature was fixed at 260° C. The presence of various peaks in the spectra represents specific CₘHₙ components of petroleum. FIGS. 4C and 4D show the representative spectra of the petroleum sample before and after passing through the nanotube filter, respectively. The presence of heavier hydrocarbon components in the unfiltered samples in FIG. 4C gives rise to the sharp peaks (marked by asterisks in the spectrum). The elimination or marked reduction of heavier hydrocarbons by the nanotube filter is seen in the spectrum obtained for the filtered sample in FIG. 4D. The elimination of the heavier hydrocarbons using the bulk tube filter was performed several times with reproducible results.

FIGS. 5A and 5B illustrate another example of petroleum filtration. The sample was filtered through the nanotube filter. The sample was analyzed using gas chromatography before and after filtration. A gas chromatography Chrompack capillary column (CP-Sil PONA CD) having a length of 100 m, an inner diameter of 250 μm, and a loop volume for injection of 5 μl was used in this example. The temperature of the column oven was set at 50° C. for 5 minutes, then raised to 100° C. at the rate of 5° C./min, and finally up to 250° C. at the rate of 10° C./min. The detector was fixed at 260° C. The flow/pressure was 1 psi of carrier gas (N₂). FIGS. 5A and 5B represent the spectra of the petroleum sample before and after passing through the nanotube filter, respectively. A comparison of the FIGS. 5A and 5B (which represent only a specific region of the spectrum) reveals an interesting result of selective filtration. It can be seen from the spectrum that the cyclic compounds that have several branches and sub-branches in addition to linear C—H chains (e.g., C₉ Naphthene, Cis 1,2 dimethyl cyclohexane (Cis 1,2 DMCC 6), cyclooctane (CC 8) and 1,1,4 trimethyl cyclohexane) are filtered (i.e., blocked) by the carbon nanotube filter. On the other hand, the normal fraction consisting of nearly linear C—H chains, e.g., n-octane (˜58.45 minutes) remains unfiltered (i.e., passes through the filter). The filtration results for petroleum are summarized in Table 1 below. Thus, the filter may be used to separate linear organic compounds from cyclic and/or branched organic compounds, including separating linear from cyclic and/or branched hydrocarbon compounds.

TABLE 1

| | Retention time | Compound | Retention time |
|---|---|---|---|
| Compound filtered | (minutes) | unfiltered | (minutes) |
| C₉ Naphthene | 61.88 | n-octane | 58.45 |
| Cis 1,2 dimethyl | 64.30 | | |
| cyclohexane | 64.51 | | |
| Cyclooctane | 69.13 | | |
| 1,1,4 trimethyl | | | |
| cyclohexane | | | |

Another example illustrates the separation of a mixture of naphthalene and benzene and further demonstrates the selectivity of the free-standing nanotube filter. The detection conditions were as follows. The GC setup (Saturn GC/MS) contained a Chrompack capillary column (CP-Sil PONA CD) with a length of 100 m, an inner diameter of 250 μm, and a loop volume for injection of 10 μl. The GC was used with flame ionization detector in the filtration experiments. The temperature of the column oven was set at 50° C. for 1 minute then raised to 200° C. at the rate of 10° C./mm. The detector was fixed at 220° C. The flow/pressure is 2 psi of carrier gas (N₂). GC graphs were analyzed by various detailed hydrocarbon analysis (DHA version 5.5) software, which consists of a hydrocarbon bank for proper calibration. Before performing the experiments with the actual samples, 18 known compounds were used to calibrate the detector. The solution was prepared by using 4 g of naphthalene dissolved in 10 ml of benzene. FIG. 6A shows a GC spectrum of a sample of the benzene/naphthalene mixture before filtration. FIG. 6B shows a GC spectrum of the portion of the same sample that passed through the nanotube filter. The retention time x-axis) is plotted with respect to arbitrary amplitude signals, volts in this case (y-axis). The spectra of FIGS. 6A and 6B suggest that naphthalene (retention time ˜34.8 minutes) gets filtered (i.e. blocked by the nanotube filter) while benzene does not. Indeed, the separation coefficient (α=7.5 for the just-filtered sample; and 6 and 5.8 for the samples filtered after 10 and 20 minutes, respectively) determined from the relative peak areas of the GC spectrum indicates that naphthalene is adsorbed in the first few minutes and saturates in ˜10 minutes. Thus, the filter may be used to separate higher molecular weight organic compounds from lower molecular weight organic compounds.

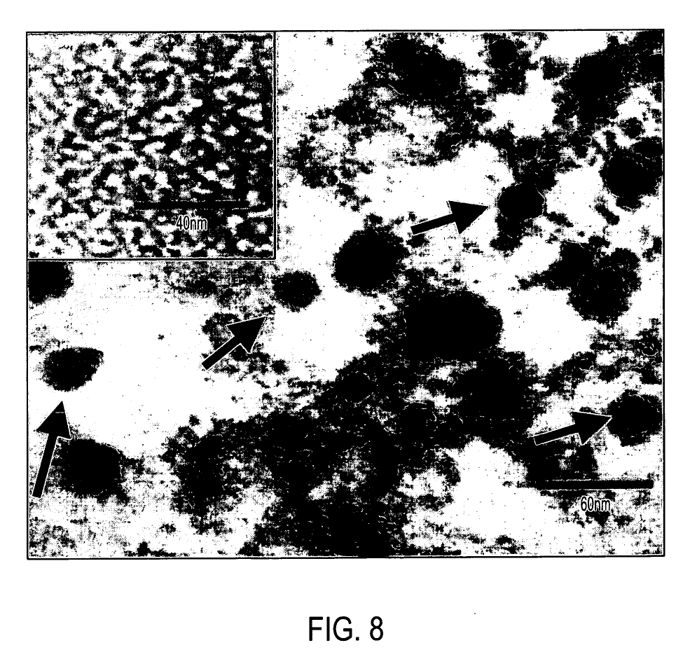

Further use of the nanotube filters was evaluated for the successful removal of bacterial contamination from drinking water. A common pollutant of drinking water is the fecal bacterium Escherichia coli having a typical length of 2,000 nm to 5,000 nm and width 400 to 600 nm. This bacteria is responsible for many waterborne diseases. The nanotube filter was shown useful for filtering such common pollutants from drinking water. Sterile saline water with light E coli bacterial suspension (˜10⁶ organisms per ml) was analyzed. FIG. 7A is a photograph of the suspension, which has a light pink and turbid color, due to the fact that the bacteria colonies were scraped from the surface of MacConey agar, which contains Phenol red as an indicator. This suspension was cultured in solid as well as liquid media and incubated at ˜37° C. overnight. FIG. 7B shows that this unfiltered solution contains a growth of bacterial colonies indicated by arrows. A sample of a bacterial suspension (˜10⁶ organisms per ml) was then subjected to a filtration process 50 of one embodiment of the present invention depicted in FIG. 7C. The hollow cylindrical carbon nanotube filter 22 was closed at one end with a cap 52 and was placed inside a container 54. The liquid was flowed into an inlet funnel 56 and a portion of the liquid passed from the interior portion of the filter 22 to an exterior portion of the filter 22 through nanopores between the nanotubes. FIG. 7D shows the portion of the water that had passed through the filter (i.e., the filtrate). The product obtained is relatively clear compared with the original unfiltered suspension in FIG. 7A, indicating a reduction of the concentration of bacteria (as well as coloring particles) in the filtrate relative to the unfiltered solution. To confirm this and to check the efficiency of the filtration process, the filtrate was cultured in solid as well as liquid media and incubated at ˜37° C. overnight. The growth of bacterial colonies was suppressed in the filtrate, as shown in FIG. 7E.

Similar successful filtration was also achieved for another bacterium, Staphylococcus aureus, with a spherical size of 1,000 nm, smaller than E. coli. Similar to the case of water with E. coli bacteria, it was possible to remove the S. aureus bacteria entirely from water through filtration by the present nanotube filters. This efficient bio-adsorptive property of the filters was also tested for much smaller (nanoscale dimensions) species, viruses. A polio-1 (poliovirus sabin 1, having sizes ˜25 to 30 nm with a molecular mass of 8.5×10⁶ daltons, and having icosahedral shapes) was used. Stained Sabin 1 is the polio vaccine, which is attenuated (weakened) so the virus becomes impotent towards harming the central nervous system. Liquid containing suspension of 10⁶ particles per milliliter of polio-1 virus was analyzed. This polio suspension was subjected to filtration process through the nanotube filters following the same technique as used for the bacterial (E-coli) filtration. In order to confirm the filtration of the virus, both unfiltered and filtered samples were investigated by TEM. A fine pipette was used to add a drop of the specimen on the carbon evaporated formvar coated copper grid (300 mesh). FIG. 8 shows TEM images of the solution containing the poliovirus (pointed by arrows) before and after (inset) passing through the nanotube filter. The inset essentially shows the grains of the formvar support. Presence of the poliovirus was not found in the solution after it was passed through the nanotube filter indicating the efficient separation of these viruses using the macro filters. The filtration processes were repeated several times with completely reproducible results.

Steady flow rates are observed during the filtration experiments for a significant amount of time. Using the area of the membrane tube (5.55 cm²), the flow rates were found to be 1.8 ml min⁻¹ cm² for petroleum, 1.1 ml min⁻¹ cm² for contaminated water and 2.2 ml min⁻¹ cm² for the benzene and naphthalene mixture. The typical pressure difference was ˜8.8×10³ Pa. The filtration process itself was driven by gravity as no additional pressure was applied. It is believed that the confined geometry of the nanotubes (and hence nanoporosity) and the selective adsorption behavior of the nanotube surfaces are both useful in the filtration process. Because the inter-tubular spaces dominate the porosity in the membrane, and as many of the nanotube's internal spaces possibly have plugs of metal particles, it is believed that most of the filtering occurs in the interstitial spaces. However, there might be some transport through the inner hollow channels of the nanotubes, but the exact distribution of these two mechanisms is very difficult to quantify. One concern in all the above-mentioned filtering processes is fouling. However, the uniform dense packing of the nanotubes in the radial direction of the solid macrotube provides an ideal geometry for cross-flow filtration favoring minimum blockage, and is effective for cleaning the filters with purging cycles.

A major advantage of using the nanotube filters of the present invention over conventional membrane filters lies in the fact that the nanotube filters can be cleaned repeatedly after each filtration process to regain their full filtering efficiency. A simple process of ultrasonication and autoclaving (˜121° C. for 30 mins) was found to be sufficient for cleaning these filters. Cleaning can also be achieved by purging for the reuse of these filters. In conventional cellulose nitrate/acetate membrane filters used in water filtration, however, strong bacterial adsorption on the membrane surface affects their physical properties preventing their reusability as efficient filters; most of the typical filters used for virus filtration (e.g., Millipore) are not reusable. Because of the high thermal and chemical stability of the nanotubes, the nanotube filters of the present invention can also be operated at temperatures of ˜400° C., which are several times higher than the highest operating temperatures of the conventional polymer membrane filters (˜52° C.).

The foregoing description of the invention has been presented for purposes of illustration and description. It is not intended to be exhaustive or to limit the invention to the precise form disclosed, and modifications and variations are possible in light of the above teachings or may be acquired from practice of the invention. The description was chosen in order to explain the principles of the invention and its practical application. It is intended that the scope of the invention be defined by the claims appended hereto, and their equivalents. All publications mentioned herein as well as U.S. published application US-2003/0165418-A1, are incorporated by reference in their entirety.

What is claimed is:

1. A monolithic, macroscopic, nanoporous nanotube filter, wherein the filter comprises at least one of a hollow or a self-supporting filter.

2. The filter of claim 1, wherein the filter consists essentially of a self-supporting array of carbon nanotubes.

3. The filter of claim 1, wherein the filter comprises a hollow filter.

4. The filter of claim 3, wherein the filter consists essentially of a self-supporting array of carbon nanotubes.

5. The filter of claim 3, wherein the filter comprises a cylindrical array of radially aligned multi-walled carbon nanotubes having at least one open end.

6. The filter of claim 1, wherein:
the filter comprises a hollow, self-supporting array of radially aligned, multi-walled nanotubes;
the filter comprises a length and diameter of more than one centimeter; and
nanopores are located between adjacent nanotubes of the array.

7. The filter of claim 1, wherein the filter comprises chemically functionalized nanotubes to allow selective chemical filtration of an analyte fluid through the filter.

8. The filter of claim 1, wherein the filter is located inside a microcapillary and the nanotubes of the filter comprise an array of radially aligned nanotubes located on the inner wall of the microcapillary.

9. A method of filtering a fluid comprising passing the fluid through the filter of claim 1.

10. The method of claim 9, further comprising collecting a portion of the fluid that has passed through the filter.

11. The method of claim 10, wherein:
the filter comprises a hollow, self-supporting array of radially aligned multi-walled carbon nanotubes having at least one open end;
the step of passing the fluid comprises passing the fluid into an interior portion of the hollow filter through the at least one open end; and
the step of collecting comprises collecting a portion of the fluid that has passed from the interior portion of the hollow filter to an exterior portion of the filter through nanopores between the nanotubes.

12. The method of claim 10, wherein the fluid comprises a hydrocarbon fluid or contaminated water.

13. The method of claim 12, wherein:
the fluid comprises an oil hydrocarbon fluid;
the step of collecting comprises collecting petroleum components having a chemical composition CₘHₙ where n=2m+2 and 1≦m≦12 that have passed through the nanopores between the nanotubes; and
heavy hydrocarbon components having a chemical composition CₘHₙ such that m>12 are filtered by the filter.

14. The method of claim 12, wherein the fluid comprises water that contains biological species and the method comprises filtering of the biological species from water.

15. The method of claim 14, wherein the biological species comprise at least one of a bacteria or a virus.

16. The method of claim 9, further comprising:
cleaning the filter using at least one of an acid treatment, ultrasonication, or autoclaving following the step of passing the fluid through the filter;
passing additional fluid through the filter after the step of cleaning.

17. A method of making a carbon nanotube filter, comprising:
(a) providing a carbon nanotube source gas and a catalyst gas onto a heated surface;
(b) forming a carbon nanotube filter comprising an array of aligned nanotubes containing nanopores between the nanotubes on the surface; and
(c) removing the carbon nanotube filter from the surface.

18. The method of claim 17, wherein the step of removing of the nanotube filter from the surface comprises infiltrating an acid at the interface between the nanotube filter and the surface.

19. The method of claim 17, wherein the source gas comprises benzene and the catalyst gas comprises ferrocene and a temperature of the furnace ranges from about 700° C. to about 1100° C. during the step of forming.

20. The method of claim 17, wherein the surface is the inner wall of a hollow tube.

21. The method of claim 17, wherein the step of forming the nanotube filter on the surface comprises using a continuous spray pyrolysis method by providing the source gas and the catalyst gas to the surface through a nozzle.

22. The method of claim 21, further comprising moving the nozzle and the surface relative to each other to deposit the filter in selected locations on the surface.

23. The method of claim 21, further comprising:
providing a mask which masks at least a first portion of the surface;
forming the filter on at least one second portion of the surface that is not covered by the mask; and
removing the mask.

24. The method of claim 17, wherein the step of forming a nanotube filter on the surface comprises forming a hollow, self-supporting array of aligned multi-walled carbon nanotubes growing in radial directions on the surface.
